(19) United States
(12) Patent Application Publication
(10) Pub. No.: US 2003/0222370 A1
(43) Pub. Date: Dec. 4, 2003

(54) Method for manufacturing EVA outsoles

(76) Inventors: Ching-Chin Chen, Taichung (TW); Shih-Kan Liang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/159,038

(22) Filed: Jun. 3, 2002

(51) Int. Cl. B29D 1/00

(52) U.S. Cl. 264/51; 264/321

(57) ABSTRACT

A method for manufacturing EVA outsoles includes step 1 to mix EVA and foaming agent to become a mixture; step 2 to form the mixture as mentioned in step I to be particles or semi-fluid; step 3 to accumulate the particles or the semi-fluid to have a desired weight; step 4 to put the particles or the semi-fluid having the desired weight in step 3 into a mold to form an outsole, and step 5 to trim the outsoles.

### FIELD OF THE INVENTION

The present invention relates to a method for manufacturing EVA outsoles and the method involves less number of steps and saves more EVA material.

### BACKGROUND OF THE INVENTION

A method known to applicant about the steps for manufacturing EVA outsoles is shown in FIG. 1 and includes the following steps:

step 1: mixing EVA, related components and foaming agent;

step 2: pressing the mixture as mentioned in step 1 to be a plate;

step 3: cutting the plate into strips;

step 4: using a foaming machine to foam the strips;

step 5: peeling a top surface and a bottom surface of each strip;

step 6: shaping the foamed strips to be a desired shape;

step 7: trimming each strip in step 6, and

step 8: heating the strips in step 7 in a mold to forming the strips into outsoles.

This method involves too many steps and only a certain amount of EVA can be utilized because too much EVA material is discarded when peeling the top surface and the bottom surface of the strips.

The present invention intends to provide a method for manufacturing EVA outsole and the steps of the method are fewer than the conventional method and the EVA material can be saved about 30% to 40% of the quantity of EVA material that is used in conventional method.

### SUMMARY OF THE INVENTION

In accordance with one aspect of the present invention, there is provided a method for manufacturing EVA outsoles, comprising the following steps:

step 1: mixing EVA and foaming agent to become a mixture;

step 2: forming the mixture as mentioned in step 1 to be particles or semi-fluid;

step 3: accumulating the particles or the semi-fluid to have a desired weight;

step 4: putting the particles or the semi-fluid having the desired weight in step 3 into a mold to form an outsole, step 5: trimming the outsoles.

The EVA material is not discarded during the steps of the method of the present invention so that the EVA material is used effectively.

The patterns of the outsole can be directly formed in the outsoles by the mold so that it takes less time to manufacture the outsoles.

These and her objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is a flow chart to show a conventional method for manufacturing EVA outsoles, and

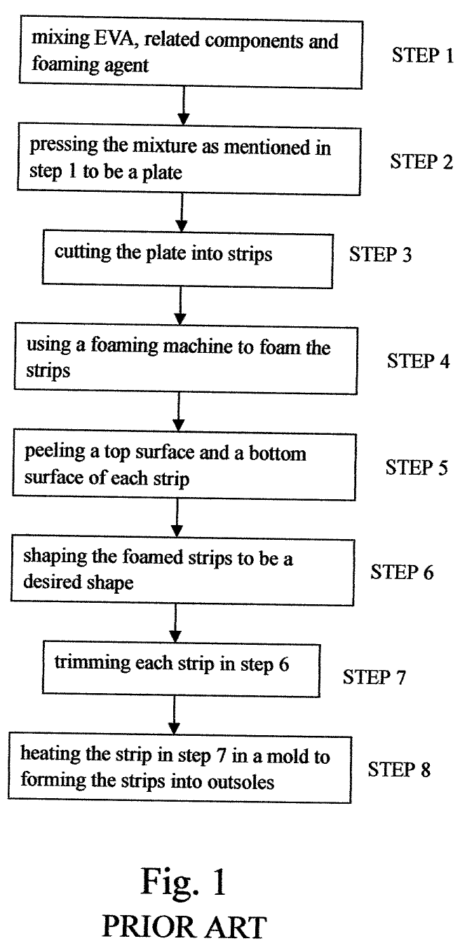

FIG. 2 is a flow chart to show a method for manufacturing EVA outsoles in accordance with the present invention.

### DETAILED DESCRIPTION OF THE PREFERRED EMBODIMENT

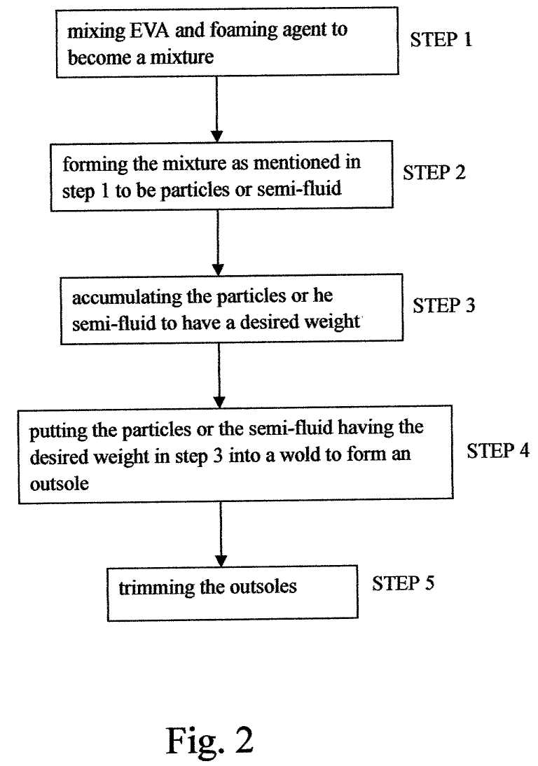

Referring to FIG. 2, the method in accordance with the present invention comprises the following steps which are:

step 1: mixing EVA and foaming agent to become a mixture;

step 2: forming the mixture as mentioned in step 1 to be particles or semi-fluid;

step 3: accumulating the particles or the semi-fluid to have a desired weight;

step 4: putting the particles or the semi-fluid having the desired weight in step 3 into a mold to form an outsole, wherein the mold has pattern defined in an inside thereof, and

step 5: trimming the outsoles.

In the method, there is no peeling process so that the EVA material can be saved about 30% to 40% of the quantity of EVA material that is used in the conventional method. The mold has patterns defined in an inside thereof so that the outsoles made by the method of the present invention are final products. The size of the mold mentioned in step 5 is ½ to ⅔ of the fill size of a conventional mold.

While we have shown and described various embodiments in accordance with the present invention, it should be clear to those skilled in the art that further embodiments may be made without departing from the scope and spirit of the present invention.

What is claimed is:

1. A method for manufacturing EVA outsoles, comprising:
step 1: mixing EVA and foaming agent to become a mixture;
step 2: forming the mixture as mentioned in step 1 to be particles or semi-fluid;
step 3: accumulating the particles or the semi-fluid to have a desired weight;
step 4: putting the particles or the semi-fluid having the desired weight in step 3 into a mold to form an outsole, and
step 5: trimming the outsoles.
